(19) United States
(12) Patent Application Publication
(10) Pub. No.: US 2019/0332558 A1
(43) Pub. Date: Oct. 31, 2019

(54) LOW-POWER STATES IN A MULTI-PROTOCOL TUNNELING ENVIRONMENT

(71) Applicant: QUALCOMM Incorporated, San Diego, CA (US)

(72) Inventor: James Goel, Ajax (CA)

(21) Appl. No.: 16/392,813

(22) Filed: Apr. 24, 2019

Related U.S. Application Data
(60) Provisional application No. 62/662,589, filed on Apr. 25, 2018.

(51) Int. Cl. G06F 13/20; H04L 12/805; H04L 12/891; G06F 13/42

(52) U.S. Cl. CPC G06F 13/20; H04L 47/365; G06F 2213/0042; G06F 13/4282; G06F 2213/0024; H04L 47/41

(57) ABSTRACT

A power circuit is added at a host that determines that a native protocol using a given lane within a tunneled environment has entered a low-power state and provides a throttle instruction to a router in the host. The router may then transmit on fewer lanes. The reduction in the number of lanes used reduces power consumption, thus preserving the value associated with the native protocol entering the low-power state.

### PRIORITY CLAIM

The present application claims priority to U.S. Patent Provisional Application Ser. No. 62/662,589 filed on Apr. 25, 2018 and entitled “LOW-POWER STATES IN A MULTI-PROTOCOL TUNNELING ENVIRONMENT,” the contents of which is incorporated herein by reference in its entirety.

### BACKGROUND

### I. Field of the Disclosure

The technology of the disclosure relates generally to communication buses and, more particularly, to a communication bus that allows native protocol tunneling between endpoints.

### II. Background

Computing devices have become common throughout society. These devices have evolved from cumbersome, limited purpose machines into small, portable, multi-function, multimedia devices. At the same time, there has been an evolution in the utilization of peripherals for such computing devices. For example, early displays were large cathode ray tube devices, which have been replaced by flat-screen monitors with resolutions at levels that exceed the capacity of the human eye to differentiate individual pixels. Several protocols have been promulgated which allow a computing device to provide information used by the display in the presentation of images thereon.

Likewise, devices such as printers have evolved from early dot matrix printers to sophisticated ink jet and laser printers. Similarly, the cables connecting such printers to a computing device have evolved through several protocols. While industry efforts to have a single protocol that allows communication between any number of devices gained traction with the advent of the Universal Serial Bus (USB) protocol, many other protocols still exist such as high definition multimedia interface (HDMI), DISPLAYPORT, Peripheral Component Interconnect (PCI), serial AT attachment (SATA), display serial interface (DSI), camera serial interface (CSI), and others that continue to be used for certain purposes.

While the functionality of computing devices has evolved, at least in the mobile computing industry, there has been pressure to make the devices relatively thin. The thinning of such mobile computing devices has caused earlier connection ports to be reconsidered and replaced with connection ports and connectors having progressively smaller form factors. For example, some recent phones have eliminated the 3.5 mm audio jack in view of a consolidated port. One relatively recent form factor is the USB Type-C connector. While initially praised as a final solution, some industry leaders have determined that USB and the Type-C protocol in particular are not optimal for their products. One proposed solution is to expand use of a tunneling protocol to provide increased flexibility. To date, such tunneling protocols make no provision for individual native source protocols signaling activities that may enter low-power modes.

### SUMMARY OF THE DISCLOSURE

Aspects disclosed in the detailed description include systems and methods for providing low-power states in a multi-protocol tunneling environment. In particular, a power circuit is added at a host that determines that a native protocol using a given lane within a tunneled environment has entered a low-power state and provides a throttle instruction to a router in the host. The router may then optimize the bandwidth of the tunneling signals to match the bandwidth being used by the native protocol. This optimization may be done by transmitting on fewer lanes or modifying transmission frequency or clock if appropriate. The reduction in the number of lanes used and/or the change in frequency or clock reduces power consumption, thus preserving the value associated with the native protocol entering the low-power state.

By managing power for lanes in this fashion, individual downstream devices may be managed independently of one another to provide a system-wide optimized power management system. For example, one downstream display may enter a deep sleep mode while downstream speakers continue to play music. Another non-limiting example would be a low-power mode that changes a native protocol clock rate. Such clock rate changes may be accommodated on a per input native protocol basis. As a more specific non-limiting example, if Universal Serial Bus (USB) lowers its clock frequency, that change can be accommodated without changing a DISPLAYPORT frequency. Further, the use of tunneled native protocols allows the downstream devices to use their original native protocol that has been delivered through the tunnel while allowing a single standardized tunneling protocol and a single form factor for the connector.

In this regard in one aspect, a method of controlling a communication bus is disclosed. The method includes putting at least one native protocol data stream into a tunneled protocol data stream. The method also includes determining at least one power transition in the at least one native protocol data stream. The method also includes adjusting a bandwidth of the tunneled protocol data stream based on a bandwidth requirement of the at least one native protocol data stream as indicated by the at least one power transition in the at least one native protocol data stream.

In another aspect, a host router is disclosed. The host router includes a bus interface configured to place a tunneled data path on a communication cable. The host router also includes a control system. The control system is configured to put at least one native protocol data stream into a tunneled protocol data stream. The control system is also configured to determine at least one power transition in the at least one native protocol data stream. The control system is also configured to change a power state of a lane corresponding to the at least one native protocol data stream responsive to the at least one power transition.

In another aspect, a method of controlling a communication bus is disclosed. The method includes putting at least one native protocol data stream into a tunneled protocol data stream. The method also includes determining power event transitions in the at least one native protocol data stream. The method also includes changing a power state of at least one lane corresponding to the at least one native protocol data stream responsive to a power event transition.

In another aspect, a host router is disclosed. The host router includes a bus interface configured to place a tunneled data path on a communication cable. The host router also includes a control system. The control system is configured to put at least one native protocol data stream into a tunneled protocol data stream. The control system is also configured to determine power event transitions in the at least one native protocol data stream. The control system is also configured to change a power state of at least one lane corresponding to the at least one native protocol data stream responsive to a power event transition.

In another aspect, a method of controlling a communication bus is disclosed. The method includes putting a plurality of native protocol data streams into a tunneled protocol data stream. The method also includes determining power event transitions in at least one native protocol data stream of the plurality of native protocol data streams. The method also includes changing a power state of at least one lane corresponding to the at least one native protocol data stream responsive to a power event transition independently of power levels of other lanes associated with others of the plurality of native protocol data streams.

In another aspect, a method of controlling a communication bus is disclosed. The method includes putting a plurality of native protocol data streams into a tunneled protocol data stream. The method also includes determining power event transitions in at least one native protocol data stream of the plurality of native protocol data streams. The method also includes changing a frequency of at least one lane corresponding to the at least one native protocol data stream responsive to a power event transition independently of frequencies of other lanes associated with others of the plurality of native protocol data streams.

In another aspect, a method of controlling a communication bus is disclosed. The method includes putting a plurality of native protocol data streams into a tunneled protocol data stream. The method also includes determining power event transitions in at least one native protocol data stream of the plurality of native protocol data streams. The method also includes changing a data rate of at least one lane corresponding to the at least one native protocol data stream responsive to a power event transition independently of data rates of other lanes associated with others of the plurality of native protocol data streams.

### BRIEF DESCRIPTION OF THE FIGURES

FIGS. 1A-1D are simplified illustrations of exemplary computing environments with cascaded peripherals including displays and speakers;

FIG. 2A is a block diagram of an exemplary computing environment with a tunneled connection between different display elements;

FIG. 2B is a hybrid time versus power diagram showing how power in different native protocol streams may fluctuate and how exemplary aspects of the present disclosure may throttle power to optimize system power levels;

FIG. 3 is a simplified illustration of a tunneled router topology with layers illustrated by way of a legend;

FIG. 4A is a block diagram of an exemplary conventional Universal Serial Bus (USB) Type-C connector pin assignment;

FIG. 4B is a block diagram of an exemplary conventional USB Type-C receptacle pin assignment;

FIGS. 5A and 5B illustrate two video frames, where one video frame is active and the other is a low-power frame;

FIG. 6 is a block diagram of an exemplary tunneling circuit for a host router according to an exemplary aspect of the present disclosure;

FIG. 7 is a more detailed block diagram of two components of the tunneling circuit of FIG. 6;

FIG. 8 is a flowchart illustrating an exemplary process for allowing a tunneling circuit to reduce lane usage responsive to a lane entering a low-power state;

FIG. 9 is a diagram of states of a state machine corresponding to the flowchart of FIG. 8 and the activity of the tunneling circuits of FIGS. 6 and 7;

FIG. 10 is a simplified block diagram of a power event aggregator used by the tunneling circuit of FIG. 7;

FIG. 11 is a simplified block diagram of a tunneled data protocol router used by the tunneling circuit of FIG. 6;

FIG. 12 is a diagram of states of a state machine corresponding to a tunneled power packet controller;

FIG. 13 is a diagram of states of a state machine corresponding to a direct current (DC) static power event manager circuit; and

FIG. 14 is a block diagram of an exemplary processor-based system that can include the modified tunneling topologies of the present disclosure.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include systems and methods for providing low-power states in a multi-protocol tunneling environment. In particular, a power circuit is added at a host that determines that a native protocol using a given lane within a tunneled environment has entered a low-power state and provides a throttle instruction to a router in the host. The router may then optimize the bandwidth of the tunneling signals to match the bandwidth being used by the native protocol. This optimization may be done by transmitting on fewer lanes or modifying transmission frequency or clock if appropriate. The reduction in the number of lanes used and/or the change in frequency or clock reduces power consumption, thus preserving the value associated with the native protocol entering the low-power state.

By managing power for lanes in this fashion, individual downstream devices may be managed independently of one another to provide a system-wide optimized power management system. For example, one downstream display may enter a deep sleep mode while downstream speakers continue to play music. Another non-limiting example would be a low-power mode that changes a native protocol clock rate. Such clock rate changes may be accommodated on a per input native protocol basis. As a more specific non-limiting example, if Universal Serial Bus (USB) lowers its clock frequency, that change can be accommodated without changing a DISPLAYPORT frequency. Further, the use of tunneled native protocols allows the downstream devices to use their original native protocol that has been delivered through the tunnel while allowing a single standardized tunneling protocol and a single form factor for the connector.

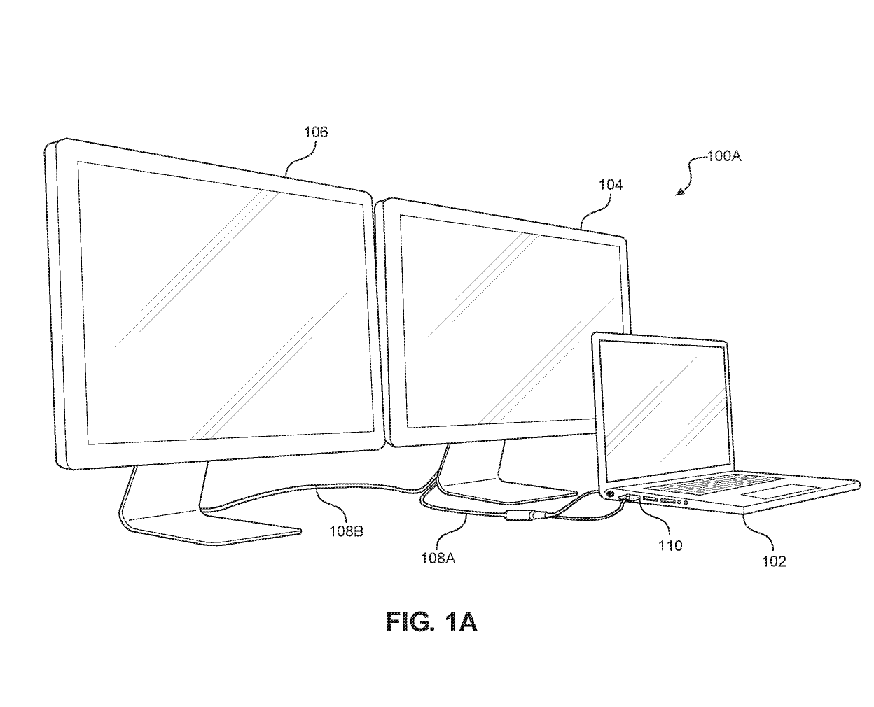

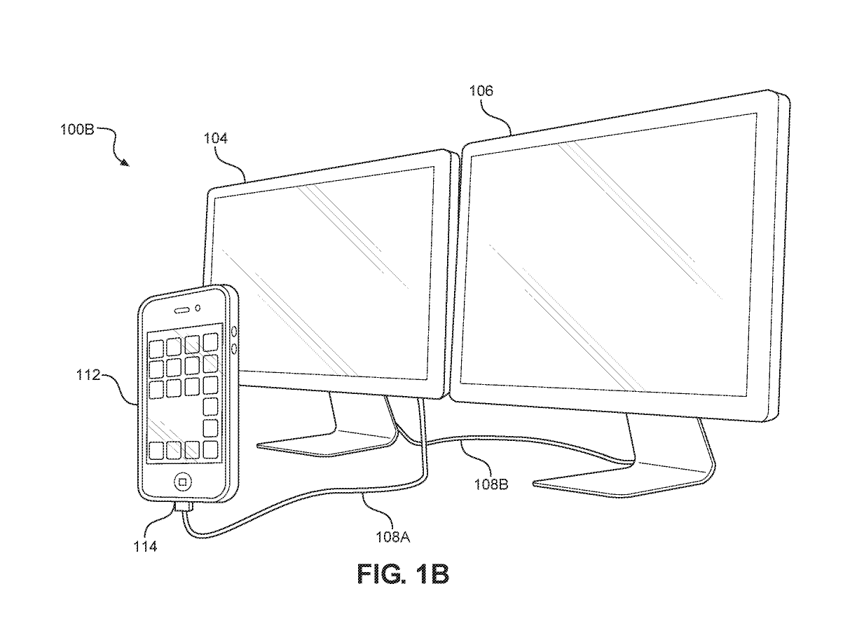

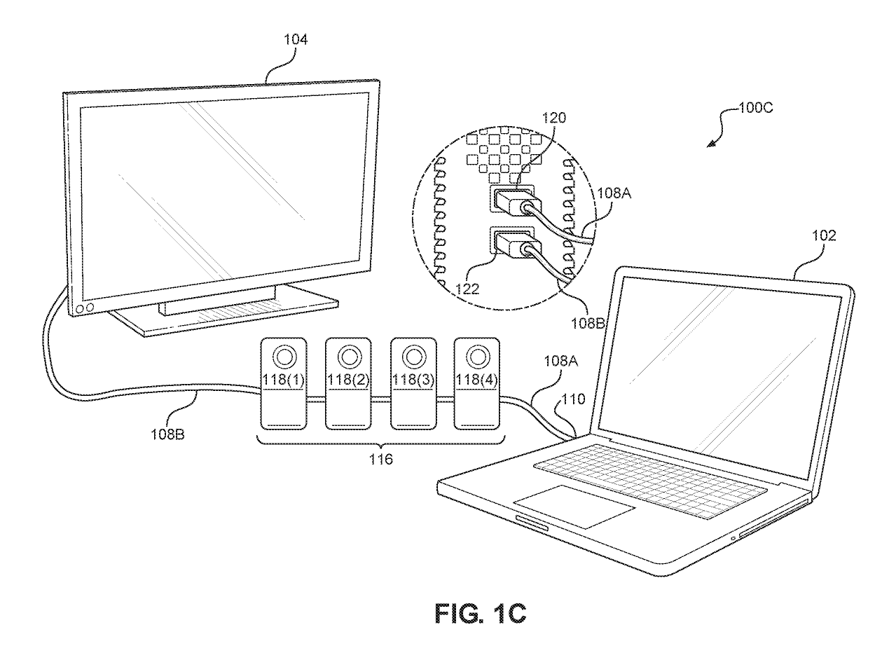

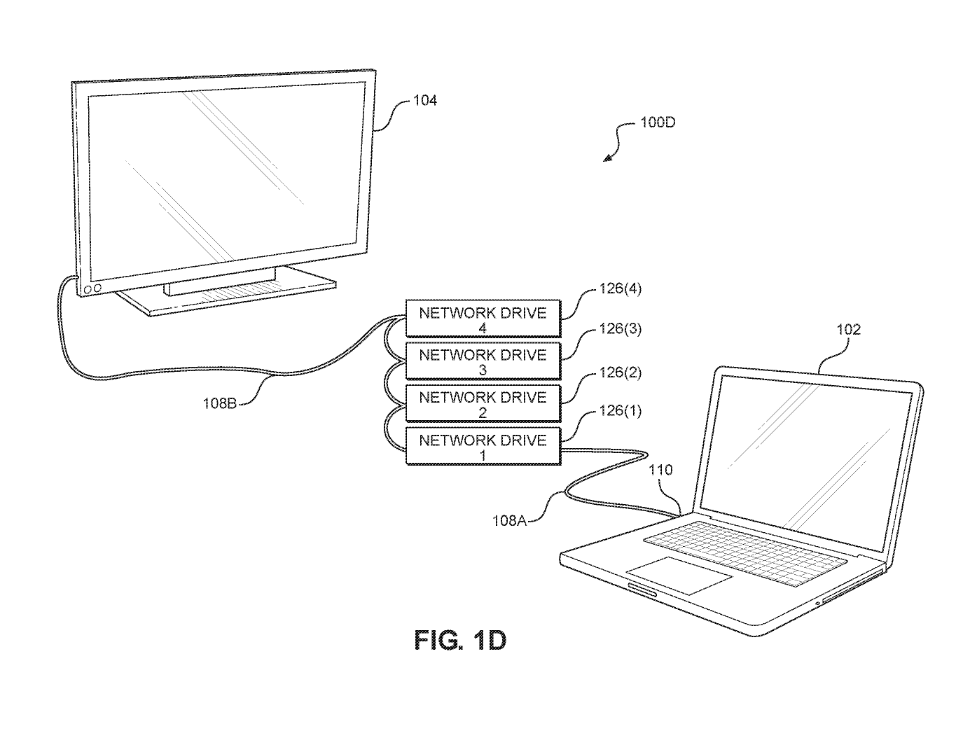

In this regard, FIG. 1A is a simplified illustration of a computing environment 100A where a laptop computer 102 is coupled to a first display 104 and a second cascaded display 106 through cables 108A and 108B. In particular, the cable 108A plugs into a port 110 on the laptop computer 102 and the first display 104 through an input port (not shown). The cable 108B plugs into an output port (not shown) of the first display 104 and an input port (not shown) of the second cascaded display 106.

Similarly, FIG. 1B illustrates a computing environment 100B where a mobile terminal 112 such as a tablet or smart phone is coupled to the first display 104 and the second cascaded display 106 through the cables 108A and 108B. The cable 108A plugs into a port 114 on the mobile terminal 112 and the first display 104 through an input port (not shown). The cable 108B plugs into an output port (not shown) of the first display 104 and an input port (not shown) of the second cascaded display 106.

Similarly, FIG. 1C illustrates a computing environment 100C where the laptop computer 102 is coupled to a sound system 116 having plural speakers 118(1)-118(4) and the first display 104. In the computing environment 100C, the first display 104 is cascaded relative to the sound system 116. The cable 108A plugs into the port 110 on the laptop computer 102 and the sound system 116 through an input port 120. The cable 108B plugs into an output port 122 of the sound system 116 and an input port (not shown) of the first display 104.

Similarly, FIG. 1D illustrates a computing environment 100D where the laptop computer 102 is coupled to a networked storage system 124—having a plurality of individual hard drives 126(1)-126(4)—and the first display 104. In the computing environment 100D, the first display 104 is cascaded relative to the networked storage system 124. The cable 108A plugs into the port 110 on the laptop computer 102 and the networked storage system 124 through an input port (not shown). The cable 108B plugs into an output port (not shown) of the last networked hard drive 126(1) from the networked storage system 124 and an input port (not shown) of the first display 104.

While not illustrated in the computing environments 100A-100D, it should be appreciated that the cables 108A and 108B carry tunneled signals complying with a variety of native protocols from the laptop computer 102 or the mobile terminal 112. For example, the basic tunneling protocol may be Universal Serial Bus (USB) 4.0, MIPI automation protocol (MAP), or Converged Input/Output (CIO) or a wireless tunneling protocol as modified by exemplary aspects of the present disclosure, and the native protocols may include, but are not limited to, a USB protocol, high definition multimedia interface (HDMI), DISPLAYPORT, Peripheral Component Interconnect (PCI) and variations such as PCI express (PCIE), serial AT attachment (SATA), display serial interface (DSI), camera serial interface (CSI), SOUNDWIRE NEXT, and the like to include wireless protocol data streams. Thus, in the computing environments 100A and 100B, the modified tunneling protocol, much like the traditional CIO protocol, tunnels the DISPLAYPORT protocol to both displays 104 and 106 such that both displays 104 and 106 are synchronized in their outputs even though the display 104 receives the signal first and the display 106 receives the signal second. In addition, exemplary aspects of the present disclosure contemplate separate power management of signals destined for each individual downstream device. The separate power management may be changes in the native protocol clock frequency, changes in transmission rate, changes in the number of lanes used, or the like. Individually and collectively, these changes are designed to optimize the bandwidth of the tunneling protocol to match bandwidth requirements of the native protocol.

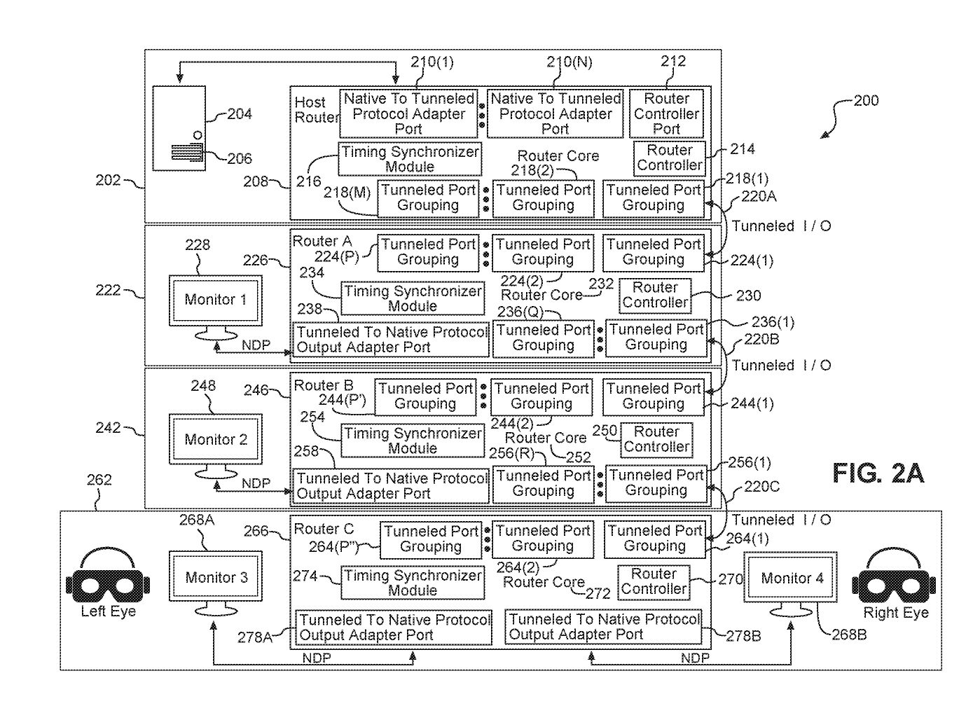

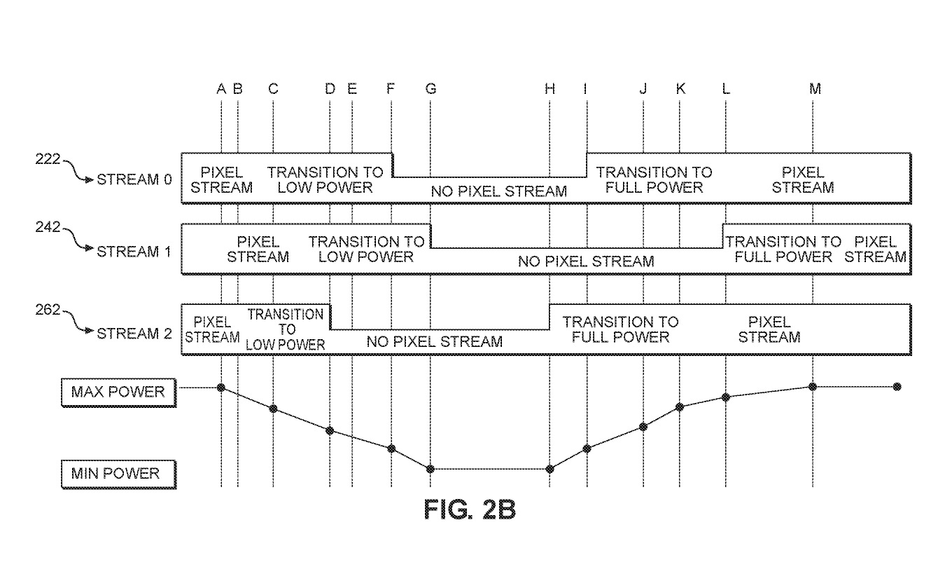

A simplified block diagram of cascaded displays coupled to a host router is provided in FIG. 2A. In particular, a computing environment 200 includes a host 202 with a control system 204 including a data source 206 that provides data in a native protocol to a host router 208. The host router 208 may have ports 210(1)-210(N) that are native-to-tunneled protocol adapter ports. In an exemplary aspect, the number N is equal to a number of different native protocols that may be tunneled. The host router 208 may further have a router controller port 212. The router controller port 212 may allow communication to and from a router controller 214. The host router 208 may further have a timing synchronizer module 216. The host router 208 may further include a plurality of tunneled port grouping output ports 218(1)-218(M). As illustrated, only the tunneled port grouping output port 218(1) has a cable 220A plugged thereinto.

The cable 220A is also coupled to a first display 222 at an input port 224(1) of a first display router 226. The first display router 226 may further include additional input ports 224(2)-224(P). The first display 222 may include a monitor 228 capable of presenting images to an end user. The first display router 226 may include a router controller 230, a router core 232, a timing synchronizer module 234, and a plurality of tunneled port grouping output ports 236(1)-236(Q). The first display router 226 may further include a tunneled-to-native protocol output adapter port 238. The tunneled-to-native protocol output adapter port 238 extracts tunneled data from a signal received at the input port 224(1) and converts it back to a native protocol (native DISPLAYPORT (NDP)) for use by the first display 222. A cable 220B is also coupled to the first display 222 at the tunneled port grouping output port 236(1).

The cable 220B is also coupled to a second display 242 at an input port 244(1) of a second display router 246. The second display router 246 may further include additional input ports 244(2)-244(P′). The second display 242 may include a monitor 248 capable of presenting images to an end user. The second display router 246 may include a router controller 250, a router core 252, a timing synchronizer module 254, and a plurality of tunneled port grouping output ports 256(1)-256(R). The second display router 246 may further include a tunneled-to-native protocol output adapter port 258. The tunneled-to-native protocol output adapter port 258 extracts tunneled data from a signal received at the input port 244(1) and converts it back to a native protocol (NDP) for use by the monitor 248. A cable 220C is also coupled to the second display 242 at the tunneled port grouping output port 256(1).

The cable 220C is also coupled to a virtual reality headset 262 at an input port 264(1) of a third display router 266. The third display router 266 may further include additional input ports 264(2)-264(P″). The virtual reality headset 262 may include a left monitor 268A and a right monitor 268B capable of presenting images to an end user. The third display router 266 may include a router controller 270, a router core 272, a timing synchronizer module 274, and a plurality of tunneled port grouping output ports (not shown). The third display router 266 may further include tunneled-to-native protocol output adapter ports 278A and 278B. The tunneled-to-native protocol output adapter ports 278A and 278B extract tunneled data from a signal received at the input port 264(1) and convert it back to a native protocol (NDP) for use by the monitors 268A and 268B.

Again, using the previous example, the displays 222 and 242 and the virtual reality headset 262 may receive tunneled DISPLAYPORT data, extract the tunneled data, and provide the tunneled data to an end user through the associated monitors.

Different displays may have different power requirements depending on what is present on the display. FIG. 2B illustrates how such native protocol power levels may fluctuate versus time and the cumulative power level. Thus, the first display 222 may correspond to stream 0, the second display 242 to stream 1, and the virtual reality headset 262 to stream 2. As is illustrated, the native protocol streams may enter low-power states independent of each other, reducing the total power requirement. For example, all streams are at maximum power at point A, but stream 2 begins to transition to low power at point B, and stream 0 begins to transition to low power at point C. Stream 2 is in the low-power state at point D, and stream 1 begins to transition to low power at point E. Stream 0 is in the low-power state at point F, and stream 1 is in the low-power state at point G. Subsequently, at point H, stream 2 begins to transition to a full-power state, and stream 0 begins to transition to a full-power state at point I. At point J, stream 2 is at full power and at point K, stream 0 is at full power. At point L, stream 1 begins transitioning to a full-power state, completing the transition at point M, when all streams are at maximum power.

Traditional CIO systems do not recognize such native protocol power changes. In contrast, exemplary aspects of the present disclosure modify the power level by matching the bandwidth of the tunneling protocol to match the bandwidth of the native protocols such as by reducing lanes, changing frequencies, or the like to optimize power consumption.

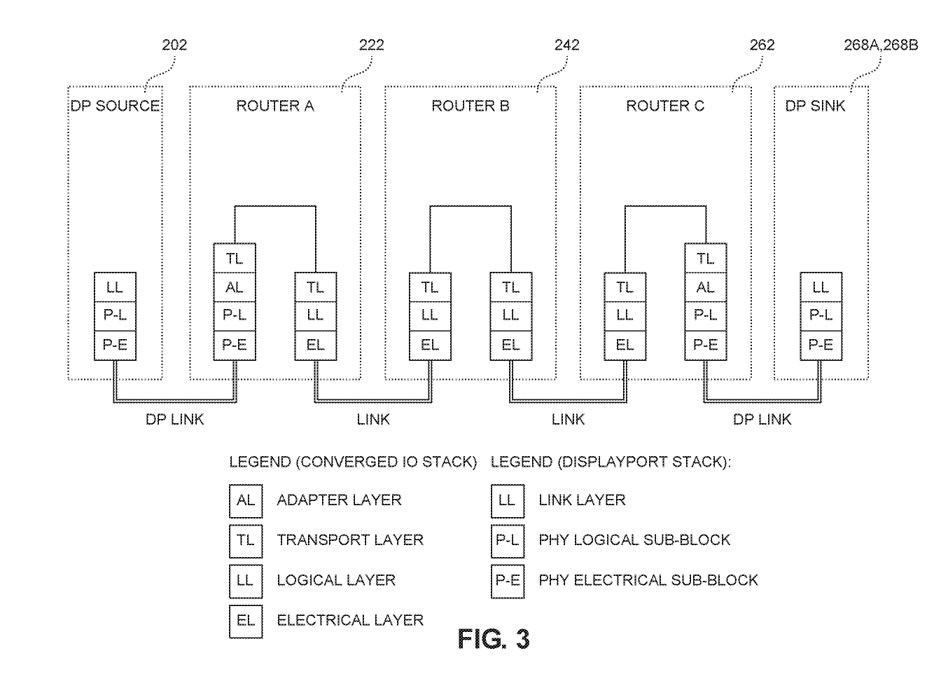

FIG. 3 provides a tunneled router topology between the host 202, the first display 222, the second display 242, the virtual reality headset 262, and the monitors 268A and 268B. The link between the first display 222 and second display 242 is a link according to the present disclosure, and the link between the second display 242 and the virtual reality headset 262 is a link according to the present disclosure.

While various types of connectors and ports can be used, exemplary aspects of the present disclosure use a pin layout based on the USB Type-C pin configuration. It should be appreciated that the USB Type-C form factor could be used or another form factor could be used with an analogous pin configuration.

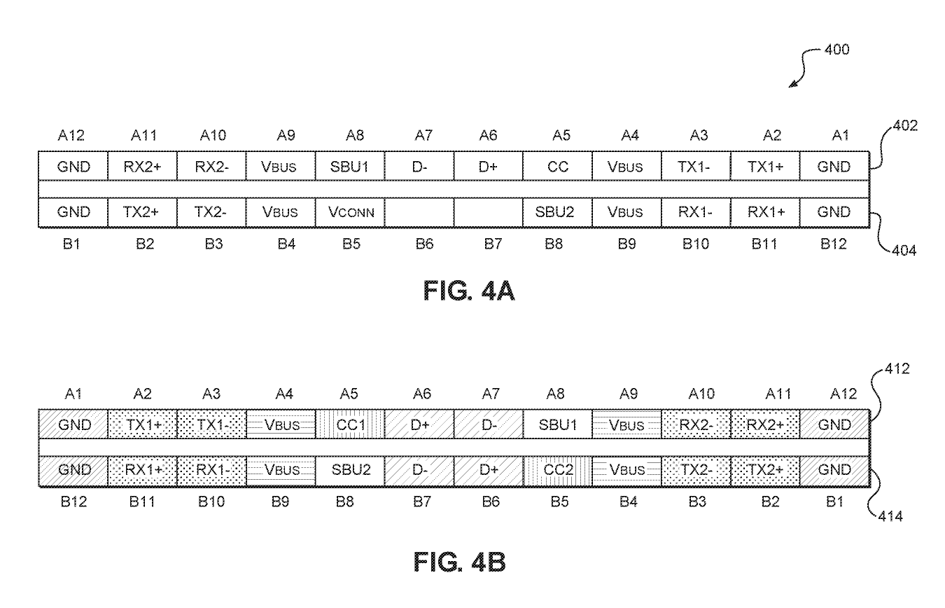

In this regard, FIG. 4A illustrates a conventional USB Type-C connector 400 (sometimes referred to as a plug). The USB Type-C connector 400 includes a top row of conductive pins 402 and a bottom row of conductive pins 404. The top row of conductive pins 402 and the bottom row of conductive pins 404 are mirror images of each other such that the USB Type-C connector 400 may be inserted in either orientation and still mate with corresponding conductive pins in a USB receptacle 410, illustrated in FIG. 4B as is well understood. The USB receptacle 410 also includes a top row of conductive pins 412 and a bottom row of conductive pins 414. Table 1, reproduced below, explains the pinouts for the USB Type-C connector 400 and the USB receptacle 410.

TABLE 1
USB Type-C connector pinouts

| Pin | Name | Description |
|---|---|---|
| A1 | GND | Ground return |
| A2 | TX1+ | SS differential pair #1 TX positive |
| A3 | TX1− | SS differential pair #1 TX negative |
| A4 | VBUS | Bus power |
| A5 | CC1 | Configuration channel |
| A6 | D+ | USB 2.0 differential pair, positive |
| A7 | D− | USB 2.0 differential pair, negative |
| A8 | SBU1 | Sideband use |
| A9 | VBUS | Bus power |
| A10 | RX2− | SS differential pair #2, RX negative |
| A11 | RX2+ | SS differential pair #2, RX positive |
| A12 | GND | Ground return |
| B12 | GND | Ground return |
| B11 | RX1+ | SS differential pair #1, RX positive |
| B10 | RX1− | SS differential pair #1, RX negative |
| B9 | VBUS | Bus power |
| B8 | SBU2 | Sideband use |
| B7 | D− | USB differential pair, negative |
| B6 | D+ | USB differential pair, positive |
| B5 | CC2 | Configuration channel |
| B4 | VBUS | Bus power |
| B3 | TX2− | SS differential pair #2, TX negative |
| B2 | TX2+ | SS differential pair #2, TX positive |
| B1 | GND | Ground return |

Exemplary aspects of the present disclosure consider when native protocols have entered a low-power mode and include circuitry that allows the tunneling protocol to match the bandwidth of the tunneled protocol to the reduced bandwidth of the native protocols by turning off lanes or otherwise performing power management activities to take advantage of the lower-power possibilities. For example, DISPLAYPORT and other video protocols may save power by not re-transmitting frames that are not changing. When there is no new data to send, or when the amount of data falls below a certain threshold relative to a packet size, the native protocol may enter a low-power mode. There are other power saving techniques embedded in various native input protocols, and aspects of the present disclosure are applicable to those other techniques. However, for the sake of illustration, a low-power state of a DISPLAYPORT protocol and a video signal is explained to better illustrate aspects of the present disclosure.

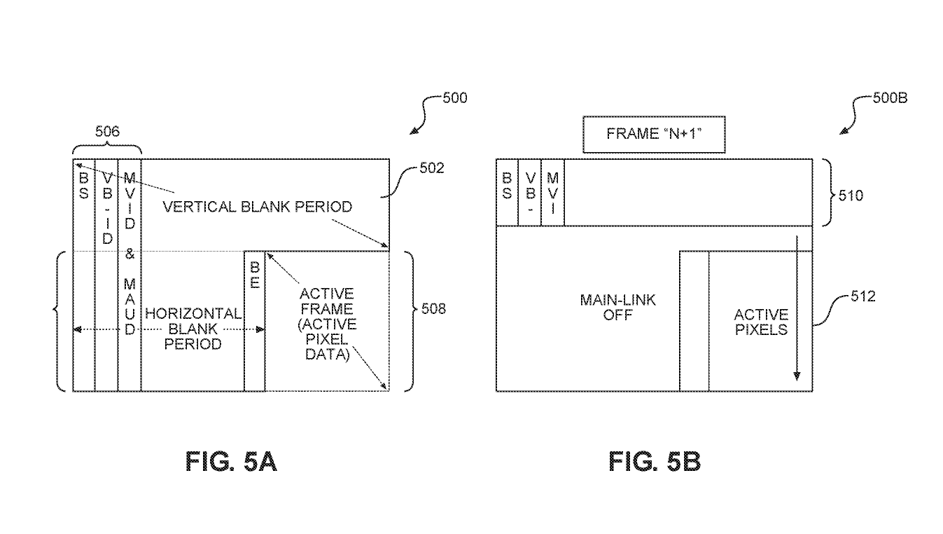

In this regard, FIGS. 5A and 5B illustrate video frames and power saving techniques. In particular, FIG. 5A illustrates a generic video frame 500 with a vertical blanking period section 502 and a horizontal blanking period section 504 as is well understood. A portion 506 of the vertical blanking period section 502 and the horizontal blanking period section 504 is devoted to sideband signals such as BS, VB-ID, MVID, and MAUD. The remaining portion of the video frame 500 is devoted to an active frame 508, which includes active pixel data. When the pixels in the active frame 508 are changing, each frame is sent with new data. However, when the pixels are relatively static, the data sent may be limited to an indication of what pixels have changed and to what new value. That is, a partial frame update may be provided where only a small section of the frame is transmitted. If the image has no change, then as illustrated in FIG. 5B, the main link is off, and the frame 500B is limited to eight lines 510 of control data and the remainder of the frame 512 is empty.

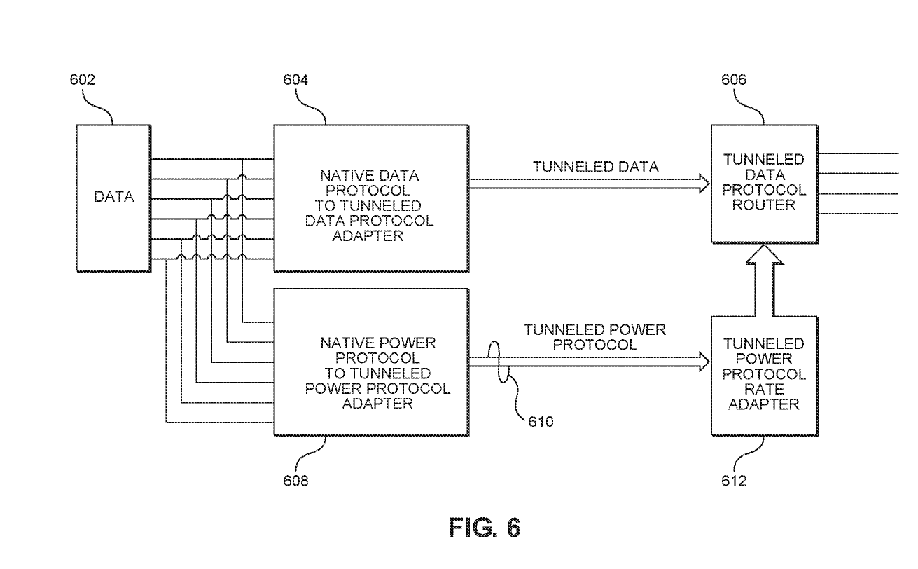

FIG. 6 is a block diagram of circuits that evaluate power signals within native protocols and control a tunneled data protocol router to take advantage of low-power states. In this regard, FIG. 6 illustrates a portion of a host router 600. Data 602 in a native protocol is initially sent over internal conductors to a native data protocol-to-tunneled data protocol adapter circuit 604. As the name implies, the native data protocol-to-tunneled data protocol adapter circuit 604 transforms the native data into tunneled data and provides the tunneled data to a tunneled data protocol router 606. Effectively the native data protocol-to-tunneled data protocol adapter circuit 604 includes the plural native-to-tunneled protocol adapter ports 210(1)-210(N) of FIG. 2, with one port for every native protocol. The tunneled data protocol router 606 is responsible for aggregating, routing, and distributing the tunneled data received from the native data protocol-to-tunneled data protocol adapter circuit 604 and placing the tunneled data onto a bus for transmission to downstream elements (e.g., displays, speakers, or the like).

With continued reference to FIG. 6, the data 602 is substantially concurrently provided to a native power protocol-to-tunneled power protocol adapter circuit 608, which analyzes power levels in the data 602 and provides a tunneled power protocol signal 610 to a tunneled power protocol rate adapter circuit 612. The native power protocol-to-tunneled power protocol adapter circuit 608 detects all incoming native power protocol transition events, encodes them in new tunneled power protocol packets, aggregates them, and sends them to the tunneled power protocol rate adapter circuit 612. Such detection may include detecting power level commands or changes in frequency indicative of a power level change. The tunneled power protocol rate adapter circuit 612 reads the incoming tunneled power protocol packets and arbitrates how to modify the signal leaving the tunneled data protocol router 606. In an exemplary aspect, the number of data lanes in the tunneled topology is reduced, thereby allowing power to be saved since a signal is not being sent during that portion of the tunneled signal. In an alternate, but not mutually exclusive aspect, a frequency of the tunneled protocol is changed.

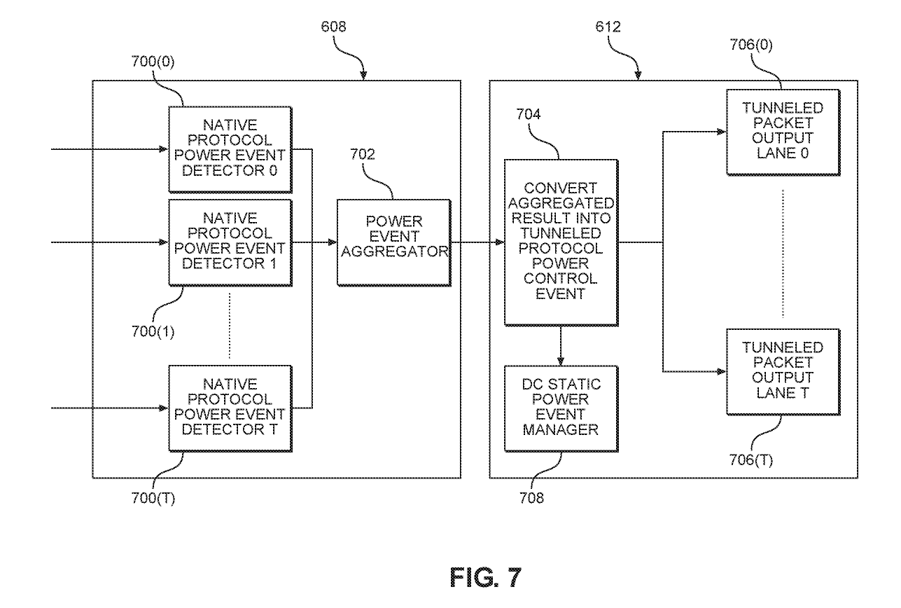

FIG. 7 illustrates a more detailed view of the native power protocol-to-tunneled power protocol adapter circuit 608 and the tunneled power protocol rate adapter circuit 612 of FIG. 6. In this regard, the native power protocol-to-tunneled power protocol adapter circuit 608 includes native protocol power event detectors 700(0)-700(T), where T corresponds to a number of possible native protocols, and a power event aggregator circuit 702. Each input native protocol should contain power transition messages that are specific to that protocol. Thus, the native protocol power event detectors 700(0)-700(T) may listen to the incoming signals and detect the power transition messages embedded in the incoming signals. Alternatively, as noted above, such power transitions may be reflected in a change in frequency. Such frequency changes may also be used to detect the power transitions. Once a power transition is detected, it is translated into a new power event signal that is provided to the power event aggregator circuit 702. It should be appreciated that the native protocols may operate at different clock speeds, and thus, the native protocol power event detectors 700(0)-700(T) may operate at different respective clock speeds. In an exemplary aspect, the power event aggregator circuit 702 receives power event signals at these different clock speeds. In another exemplary aspect, the native protocol power event detectors 700(0)-700(T) may receive an external clock signal to which they synchronize power event signals being sent to the power event aggregator circuit 702.

With continued reference to FIG. 7, the power event aggregator circuit 702 accepts any detected power event transitions from the native protocol power event detectors 700(0)-700(T) and aggregates and outputs the aggregated power events as the tunneled power protocol signal 610 at an output rate that matches the frequency output by the tunneled data protocol router 606 of FIG. 6. The order of incoming power transition events is preserved to ensure that events are positioned correctly with respect to each other and the data protocol packets being received at the tunneled data protocol router 606.

With continued reference to FIG. 7, the tunneled power protocol rate adapter circuit 612 includes a decode circuit 704 that decodes each power event into specific rate control instructions for the tunneled data protocol router 606 of FIG. 6. The rate control instructions may range from all lanes being in low-power state to all lanes being in full-power states as well as intermediate states. A lane in a low-power state may be turned off, have its frequency reduced, have packets thereon resized, or the like. The rate control instructions may control individual tunnel packet output lanes 706(0)-706(T). Additionally, the tunneled power protocol rate adapter circuit 612 may include a direct current (DC) static power event manager circuit 708. The DC static power event manager circuit 708 detects long-term or deep-sleep power transition events (e.g., such as when the user leaves a monitor alone overnight and it enters a very low-power state). Such states may allow the entire tunneled topology to be powered down.

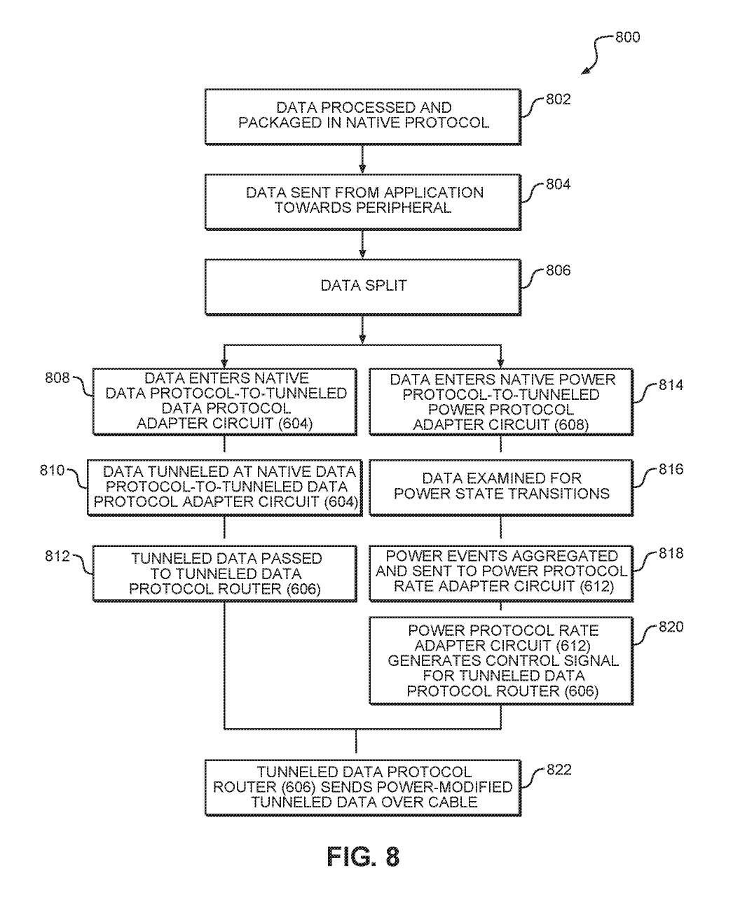

FIG. 8 provides a flowchart of a process 800 by which lane usage may be reduced responsive to one or more lanes entering a low-power state. In this regard, the process 800 begins with a native protocol data stream being processed and packaged for transmission in a native protocol (block 802). It should be appreciated that different data may be processed by different applications into different native formats. This multiple processing may occur substantially concurrently. The native protocol data stream is sent from the application towards a destination peripheral (block 804). The data is split (block 806) and routed to the native data protocol-to-tunneled data protocol adapter circuit 604 and the native power protocol-to-tunneled power protocol adapter circuit 608. Taking the native data protocol-to-tunneled data protocol adapter circuit 604 first, the data enters the native data protocol-to-tunneled data protocol adapter circuit 604 (block 808). The native protocol data stream is reformatted to be tunneled as a tunneled protocol data stream at the native data protocol-to-tunneled data protocol adapter circuit 604 (block 810). The tunneled protocol data stream is passed to the tunneled data protocol router 606 (block 812). Blocks 808, 810, and 812 are conventional. However, by considering power state transitions in the native protocol data, exemplary aspects of the present disclosure may modify the tunneled data to use fewer lanes and potentially save power.

Thus, with continued reference to FIG. 8, the data also enters the native power protocol-to-tunneled power protocol adapter circuit 608 (block 814). The data is examined to determine power state transitions (block 816). Such power state transitions may be indicated by power state transition messages indicated in the native protocol, frequency changes, or the like. Again, this examination may take place across multiple data streams in multiple different native protocols. The power events from the data streams are aggregated and sent to the tunneled power protocol rate adapter circuit 612 (block 818). The tunneled power protocol rate adapter circuit 612 generates a control signal for the tunneled data protocol router 606 (block 820). At this point, the data and the control signal are synchronized at the tunneled data protocol router 606, and the tunneled data protocol router 606 sends the power-modified tunneled data over a cable to the destination peripheral (block 822).

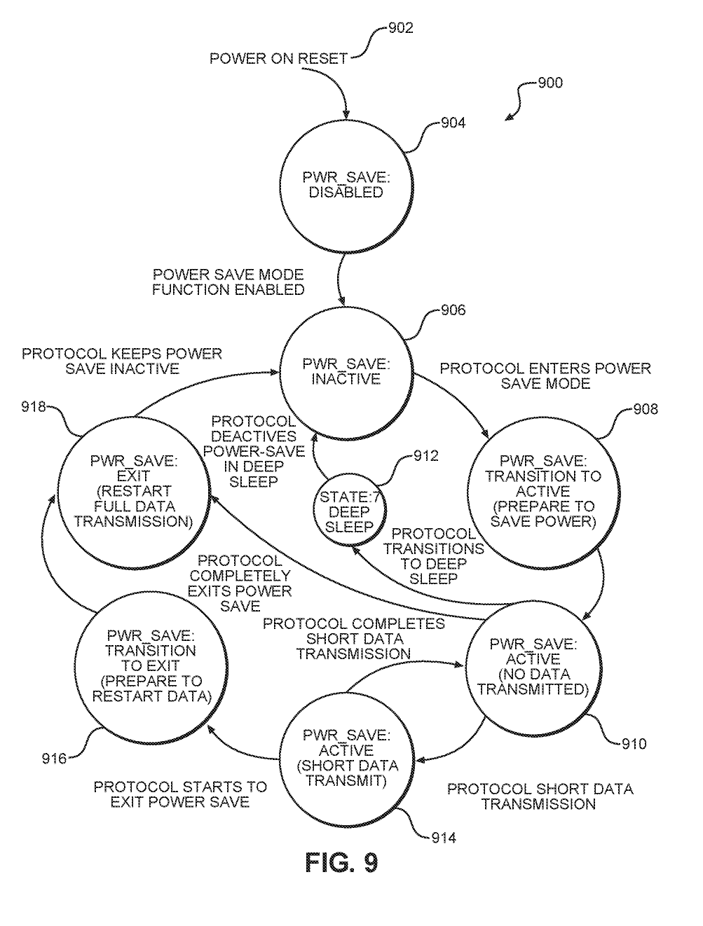

FIG. 9 provides a diagram of states of a state machine corresponding to the flowchart of FIG. 8 and the activity of the tunneling circuits of FIGS. 6 and 7. In this regard, FIG. 9 has a state machine 900 that starts with power on a reset (state 902). Initially, the power-save functions are disabled (state 904). The power-save function mode is enabled, but inactive (state 906). A native protocol enters a power-save mode and the power-save mode transitions to active (i.e., it prepares to save power) (state 908). In the power-save mode that is enabled and active, no data is transmitted on the respective lane (state 910). If the DC static power event manager circuit 708 indicates that a deep sleep is warranted because the protocol so indicates, then the tunneled data protocol router 606 enters a deep-sleep (i.e., very low power) mode (state 912). Once the protocol deactivates the power-save mode, the state machine 900 returns to state 906 from state 912.

With continued reference to FIG. 9, if the native protocol has a short transmission, then the state machine 900 allows a short data transmission while remaining in the active power-save mode (state 914). When the short transmission is over, the state machine 900 returns to state 910 or, if the native protocol indicates a power state transition out of the power-save mode, then the state machine 900 enters a state to transition or exit from the power-save mode (state 916). The router 606 should indicate an exit from the low-power state and restart full data transmission at the time when the native protocol likewise exits the low-power state (state 918). During normal data transmission, the power-save mode is inactive, and the state machine 900 returns to state 906. Note also that the state machine 900 can go straight from state 910 to state 918 if there is no intervening short transmission. As the state machine 900 transitions through each of the states in FIG. 9, a power event message is queued into an aggregator at the incoming rate of each native protocol to ensure that the transitions are synchronized at the tunneled data protocol router 606.

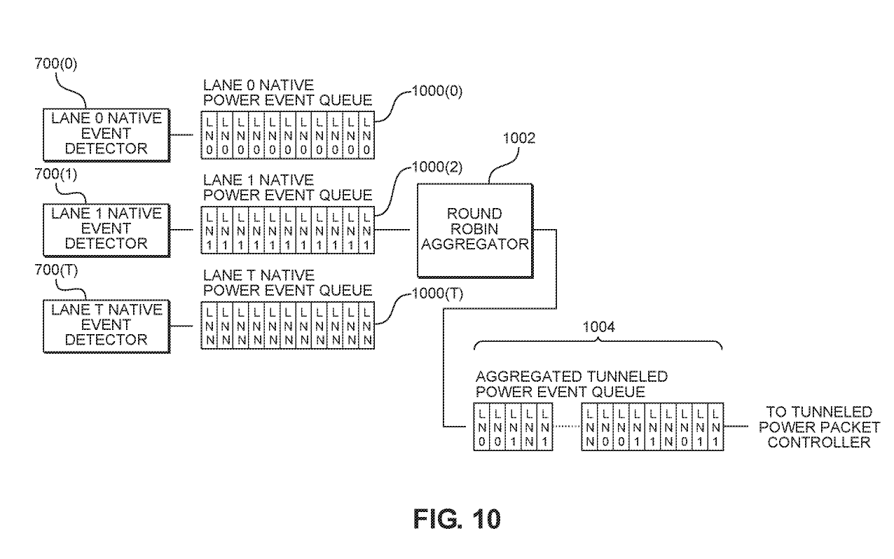

FIG. 10 is a simplified representation of how the power event aggregator circuit 702 of FIG. 7 handles power events. In particular, the native protocol power event detectors 700(0)-700(T) provide power event queue signals 1000(0)-1000(T) to a round robin aggregator 1002, which runs at a tunneled rate clock and captures each power transition event from all the power event queue signals 1000(0)-1000(T). When there is no new transition event, the last event may be retransmitted to keep the same event concurrent with the tunneled data packets and keep the two paths synchronized. An output queue 1004 is provided which is clocked at the output tunneled rate clock, and there is a specific power event for every output packet produced. These are now tunneled power events for use by the tunneled data protocol router 606.

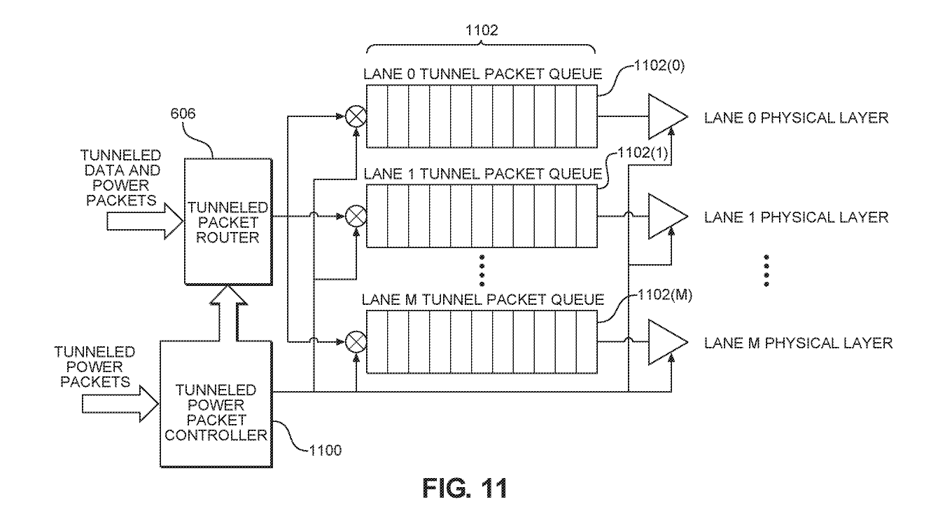

FIG. 11 is a more detailed view of the tunneled data protocol router 606 of FIG. 6. In particular, the tunneled data protocol router 606 saves power by throttling tunneled I/O data and powering up and powering down lanes in the tunneled packet router topology based on power states in the native protocol. In particular, a tunneled power packet controller 1100 contains a state machine that controls power messages sent to the tunneled data protocol router 606. Responsive to the power messages, the tunneled data protocol router 606 generates data for packet queues 1102(0)-1102(M). These packet queues contain output tunneled packets distributed over the fixed lanes of the tunneled I/O router output. Each individual lane can be power controlled and deactivated when not required. The tunneled power messages control whether the power is reduced or increased.

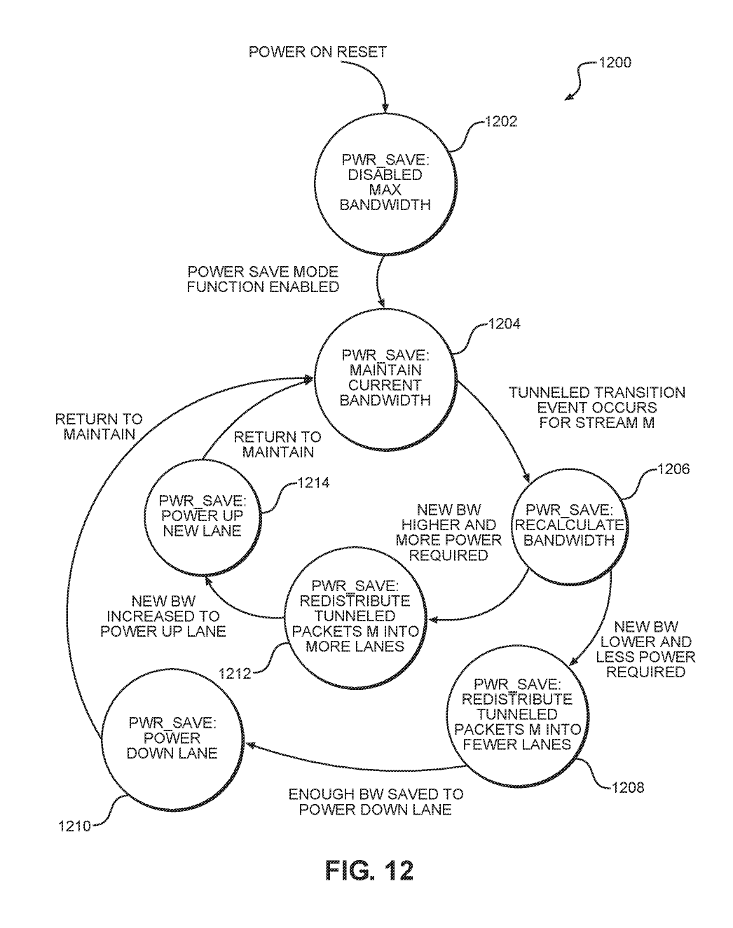

FIG. 12 illustrates a state machine 1200 associated with the tunneled power packet controller 1100 of FIG. 11. The state machine 1200 begins when power is provided on a reset and the power-save state is disabled corresponding to a maximum bandwidth being provided in the tunneled I/O router network (state 1202). The power-save mode is enabled, but the bandwidth is maintained (state 1204). At some subsequent time, a tunneled power transition event occurs for a data stream, and the state machine 1200 recalculates a required bandwidth (state 1206). If the new bandwidth is lower and less power is required, then the state machine 1200 redistributes the tunneled packets into fewer lanes (state 1208). If enough bandwidth is saved to power down an entire lane, then that lane is powered down (state 1210). The state machine then returns to state 1204. If however, at state 1206, the new bandwidth is higher and more power is required (e.g., a lane powered back up from a low-power state), the state machine 1200 redistributes the tunneled packets into more lanes (state 1212), and if the new bandwidth needs another lane, a new lane is powered up (state 1214). The state machine 1200 then returns to state 1204.

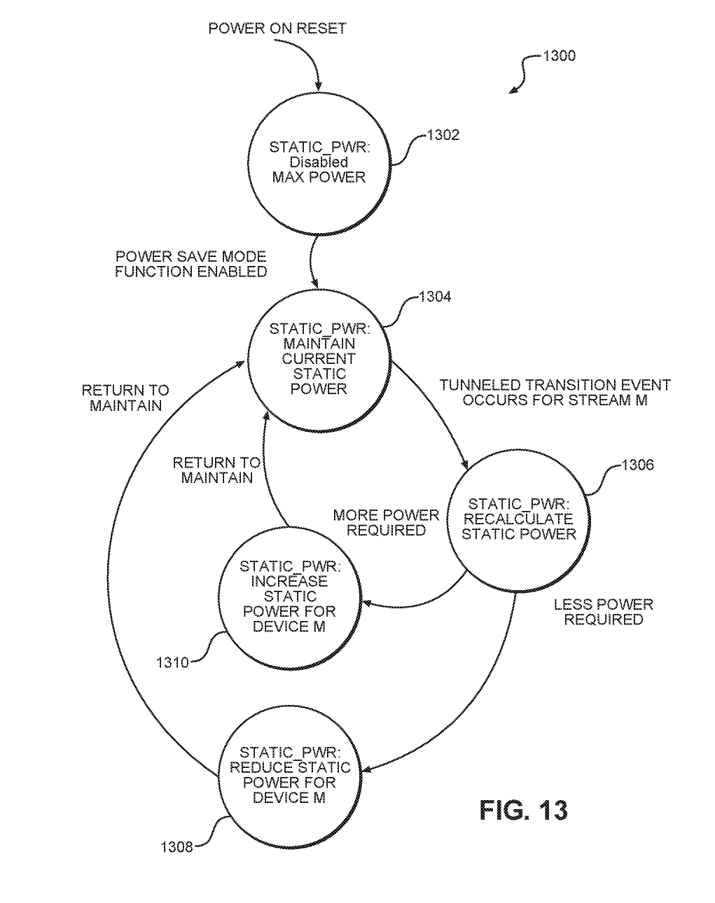

FIG. 13 illustrates a state machine 1300 corresponding to the DC static power event manager circuit 708 of FIG. 7. The state machine 1300 begins with power being provided on a reset. The static power mode is disabled and the tunneled router operates at maximum power (state 1302). At some point, the power-save mode function is enabled and the state machine 1300 maintains a stable static power (state 1304). A tunneled transition event occurs for a given data stream, and the state machine 1300 recalculates a required static power (state (1306). If less power is required, then the static power is reduced for a given device (state 1308). The state machine returns to state 1304 and provides stable power. If however, more power is required, then the state machine increases the static power (state 1310) and then returns to state 1304.

The systems and methods for providing low-power states in a multi-protocol tunneling environment according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

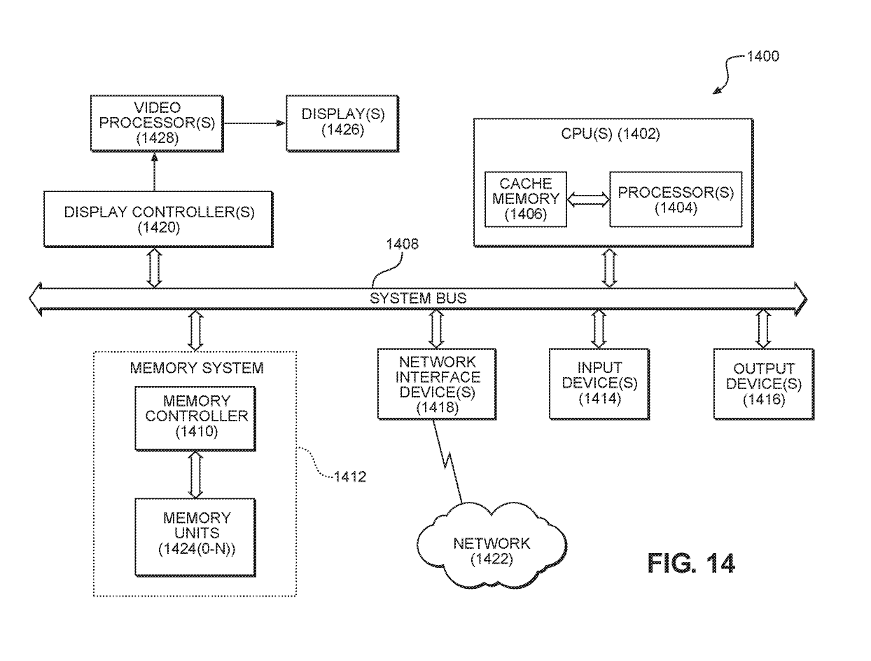

In this regard, FIG. 14 illustrates an example of a processor-based system 1400 that can employ the modified tunneling topologies of the present disclosure. In this example, the processor-based system 1400 includes one or more central processing units (CPUs) 1402, each including one or more processors 1402. The CPU(s) 1402 may have cache memory 1406 coupled to the processor(s) 1404 for rapid access to temporarily stored data. The CPU(s) 1402 is coupled to a system bus 1408 and can intercouple master and slave devices included in the processor-based system 1400. As is well known, the CPU(s) 1402 communicates with these other devices by exchanging address, control, and data information over the system bus 1408. For example, the CPU(s) 1402 can communicate bus transaction requests to a memory controller 1410 as an example of a slave device. Although not illustrated in FIG. 14, multiple system buses 1408 could be provided, wherein each system bus 1408 constitutes a different fabric.

Other master and slave devices can be connected to the system bus 1408. As illustrated in FIG. 14, these devices can include a memory system 1412, one or more input devices 1414, one or more output devices 1416, one or more network interface devices 1418, and one or more display controllers 1420, as examples. The input device(s) 1414 can include any type of input device, including, but not limited to, input keys, switches, voice processors, etc. The output device(s) 1416 can include any type of output device, including, but not limited to, audio, video, other visual indicators, etc. The network interface device(s) 1418 can be any devices configured to allow exchange of data to and from a network 1422. The network 1422 can be any type of network, including networks such as the phone network and the Internet. The network interface device(s) 1418 can be configured to support any type of communications protocol desired. The memory system 1412 can include one or more memory units 1424(0-N).

The CPU(s) 1402 may also be configured to access the display controller(s) 1420 over the system bus 1408 to control information sent to one or more displays 1426. The display controller(s) 1420 sends information to the display(s) 1426 to be displayed via one or more video processors 1428, which process the information to be displayed into a format suitable for the display(s) 1426. The display(s) 1426 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method of controlling a communication bus, comprising:
putting at least one native protocol data stream into a tunneled protocol data stream;
determining at least one power event transition in the at least one native protocol data stream; and
adjusting a bandwidth of the tunneled protocol data stream based on a bandwidth requirement of the at least one native protocol data stream as indicated by the at least one power event transition in the at least one native protocol data stream.

2. The method of claim 1, wherein determining the at least one power event transition comprises determining power event transitions.

3. The method of claim 2, wherein determining the at least one power event transition comprises splitting the at least one native protocol data stream and evaluating a split portion of the at least one native protocol data stream for native power level commands.

4. The method of claim 1, wherein putting the at least one native protocol data stream into the tunneled protocol data stream comprises putting the at least one native protocol data stream into a protocol data stream selected from the group consisting of: a Converged Input/Output (CIO) tunneled protocol data stream, a Universal Serial Bus (USB) 4 (USB4) data stream, a wireless tunneled protocol data stream, and a MIPI automotive protocol (MAP) data stream.

5. The method of claim 1, wherein putting the at least one native protocol data stream into the tunneled protocol data stream comprises putting at least one native protocol data stream complying with a native protocol selected from the group consisting of: DISPLAYPORT, Peripheral Component Interconnect (PCI), Universal Serial Bus (USB), serial AT attachment (SATA), display serial interface (DSI), and camera serial interface (CSI).

6. The method of claim 1, wherein adjusting the bandwidth comprises turning a lane off.

7. The method of claim 1, wherein adjusting the bandwidth comprises redistributing data amongst lanes on the communication bus.

8. The method of claim 1, wherein adjusting the bandwidth comprises reducing a frequency with which packets for the at least one native protocol data stream are put into the tunneled protocol data stream.

9. The method of claim 1, wherein adjusting the bandwidth comprises changing a frequency of at least one lane corresponding to the at least one native protocol data stream independently of frequencies of other lanes associated with other native protocol data streams.

10. The method of claim 1, wherein adjusting the bandwidth comprises changing a data rate of at least one lane corresponding to the at least one native protocol data stream independently of data rates of other lanes associated with other native protocol data streams.

11. The method of claim 1, wherein adjusting the bandwidth comprises adjusting a packet size in the tunneled protocol data stream.

12. The method of claim 1, wherein determining the at least one power event transition comprises detecting a frequency change in the at least one native protocol data stream.

13. A host router comprising:
a bus interface configured to place a tunneled data path on a communication cable; and
a control system configured to:
put at least one native protocol data stream into a tunneled protocol data stream;
determine at least one power transition in the at least one native protocol data stream; and
change a power state of a lane corresponding to the at least one native protocol data stream responsive to the at least one power transition.

14. The host router of claim 13, wherein the control system is configured to determine the at least one power transition by determining at least one power event transition.

15. The host router of claim 14, wherein the control system is configured to determine the at least one power event transition by splitting the at least one native protocol data stream and evaluating a split portion of the at least one native protocol data stream for native power level commands.

16. The host router of claim 13, wherein the control system is configured to put the at least one native protocol data stream into the tunneled protocol data stream by putting the at least one native protocol data stream into a protocol data stream selected from the group consisting of: a Converged Input/Output (CIO) tunneled protocol data stream, a Universal Serial Bus (USB) 4 (USB4) data stream, a wireless tunneled protocol data stream, and a MIPI automotive protocol (MAP) data stream.

17. The host router of claim 13, wherein the control system is configured to put the at least one native protocol data stream into the tunneled protocol data stream by putting at least one native protocol data stream complying with a native protocol selected from the group consisting of: DISPLAYPORT, Peripheral Component Interconnect (PCI), Universal Serial Bus (USB), serial AT attachment (SATA), display serial interface (DSI), and camera serial interface (CSI).

18. The host router of claim 13, wherein the control system is configured to adjust a bandwidth by turning a lane off.

19. The host router of claim 13, wherein the control system is configured to adjust a bandwidth by redistributing data amongst lanes on a communication bus.

20. The host router of claim 13, wherein the control system is configured to adjust a bandwidth by reducing a frequency with which packets for the at least one native protocol data stream are put into the tunneled protocol data stream.

21. The host router of claim 13, wherein the control system is configured to adjust a bandwidth by changing a frequency of at least one lane corresponding to the at least one native protocol data stream independently of frequencies of other lanes associated with other native protocol data streams.

22. The host router of claim 13, wherein the control system is configured to adjust a bandwidth by changing a data rate of at least one lane corresponding to the at least one native protocol data stream independently of data rates of other lanes associated with other native protocol data streams.

23. The host router of claim 13, wherein the control system is configured to adjust a bandwidth by adjusting a packet size in the tunneled protocol data stream.

24. The host router of claim 13, wherein the control system is configured to determine the at least one power transition by detecting a frequency change in the at least one native protocol data stream.

25. The host router of claim 13, wherein the control system comprises a native power protocol-to-tunneled power protocol adapter circuit.

26. The host router of claim 25, wherein the native power protocol-to-tunneled power protocol adapter circuit comprises a power event aggregator circuit.
